(19) United States
(12) Patent Application Publication
(10) Pub. No.: US 2025/0312786 A1
(43) Pub. Date: Oct. 9, 2025

(54) BIOLOGICAL FLUID SAMPLE ACQUISITION CARTRIDGE

(71) Applicants: Robert A. Levine, Portsmouth, NH (US); Stephen C. Wardlaw, Lyme, CT (US)

(72) Inventors: Robert A. Levine, Portsmouth, NH (US); Stephen C. Wardlaw, Lyme, CT (US)

(21) Appl. No.: 19/242,482

(22) Filed: Jun. 18, 2025

Related U.S. Application Data
(63) Continuation-in-part of application No. 17/612,242, filed on Nov. 18, 2021.
(60) Provisional application No. 62/853,275, filed on May 28, 2019.

(51) Int. Cl. B01L 3/00

(52) U.S. Cl. CPC B01L 3/5023; B01L 2200/026; B01L 2200/12; B01L 2300/069; B01L 2400/0406

(57) ABSTRACT

A cartridge is provided that includes a sample chamber assembly, a housing, and an absorbent substance. The sample chamber assembly includes a base member and an upper member. An ante-chamber is disposed between the base and upper members. An analysis chamber is disposed between the base and upper members and is in fluid communication with the ante-chamber. The ante-chamber and the analysis chamber are configured such that capillary forces draw a biological fluid sample into the ante-chamber and subsequently draw the biological fluid sample into the analysis chamber. The housing is configured to receive the sample chamber assembly such that the inlet end of the sample chamber assembly is disposed for engagement with the biological fluid sample. The absorbent substance is provided with the housing and is disposed in close proximity to the inlet end of the sample chamber assembly and is configured to absorb the biological fluid sample.

### BACKGROUND OF THE INVENTION

### 1. Technical Field

The present disclosure relates to an apparatus for acquiring and holding a biological fluid sample in general, and to an apparatus for acquiring and quiescently holding a biological fluid sample in a chamber for subsequent analysis in particular.

### 2. Background Information

The complete blood count (CBC) is the most frequently performed set of tests for whole blood and includes a number of separate analyses such as the white blood count (WBC), the red blood cell count (RBC), and platelet count, among others. The methods used vary in completeness of analyte set, complexity and cost of equipment, and per-test cost. An apparatus that can be used to perform a CBC and other tests on a whole blood sample or other tests on other biological fluids with decreased complexity and cost, and increased accuracy would be of great interest.

### SUMMARY

According to an aspect of the present disclosure, a cartridge for acquiring a biological fluid sample is provided that includes a sample chamber assembly, a housing, and an absorbent substance. The sample chamber assembly includes a base member and an upper member. An ante-chamber is disposed between the base and upper members at an inlet end of the sample chamber assembly. An analysis chamber is disposed between the base and upper members and is in fluid communication with the ante-chamber. The ante-chamber and the analysis chamber are configured such that capillary forces draw a biological fluid sample into the ante-chamber and subsequently draw the biological fluid sample from the ante-chamber and into the analysis chamber. The housing is configured to internally receive the sample chamber assembly in a manner such that the inlet end of the sample chamber assembly is disposed for engagement with the biological fluid sample. The absorbent substance is provided with the housing and is disposed in close proximity to the inlet end of the sample chamber assembly and is configured to absorb the biological fluid sample.

In any of the aspects or embodiments described above and herein, the housing may include a sample receiver that is configured to receive the biological fluid sample and to position the biological fluid sample for transfer to the ante-chamber at the inlet end of the sample chamber assembly.

In any of the aspects or embodiments described above and herein, the housing may have an axial length that extends between a first axial end and a second axial end, and the housing may include a first slot configured to receive the sample chamber assembly, wherein the first slot extends within the housing from the second axial end of the housing to the sample receiver.

In any of the aspects or embodiments described above and herein, the housing may include a first housing element and a second housing element that are configured to be attached to one another.

In any of the aspects or embodiments described above and herein, the sample receiver may be disposed in the first housing element.

In any of the aspects or embodiments described above and herein, the first slot may be formed within the second housing element.

In any of the aspects or embodiments described above and herein, the first slot may be configured to fully receive the sample chamber assembly, and the first slot may be configured such that the inlet end of the sample chamber assembly fully received within the first slot is disposed to receive biological fluid sample from the sample receiver.

In any of the aspects or embodiments described above and herein, the sample receiver may converge from an opening to an interior aperture that is positioned to permit biological fluid transfer from the sample receiver to the ante-chamber.

In any of the aspects or embodiments described above and herein, the absorbent substance may be disposed to absorb biological fluid sample that has exited the sample receiver and has not entered the ante-chamber.

In any of the aspects or embodiments described above and herein, the absorbent substance may be configured to absorb whole blood.

In any of the aspects or embodiments described above and herein, the cartridge may include a second slot, and the sample chamber assembly may include an actuator aperture configured for engagement with an actuator, and the second slot may be configured to provide access to the actuator aperture when the sample chamber assembly is received within the housing.

In any of the aspects or embodiments described above and herein, the sample chamber assembly may include a pair of first fluid barriers that in combination with the base member and the upper member define the ante-chamber, and the ante-chamber may have a first height that extends between a top surface of the base member and a bottom surface of the upper member.

In any of the aspects or embodiments described above and herein, the sample chamber assembly may include a pair of second fluid barriers that in combination with the base member and the upper member define the analysis chamber, and the analysis chamber may have a second height that extends between the top surface of the base member and the bottom surface of the upper member. The first height may be greater than the second height.

In any of the aspects or embodiments described above and herein, the ante-chamber may be configured relative to the analysis chamber such that the biological fluid sample is drawn into the ante-chamber by capillary force in a first period of time, and the biological fluid sample is drawn into the analysis chamber from the ante-chamber by capillary force in a second period of time, wherein the second period of time is greater than the first period of time.

According to an aspect of the present disclosure, a method of manufacturing a plurality of cartridges for holding a biological fluid sample is provided. The method includes: providing a base member layer having a top surface from a first continuous source; attaching a plurality of first fluid barrier portions and a plurality of second fluid barrier portions to the top surface of the base member layer; attaching a plurality of first ante-chamber inserts and a plurality of second ante-chamber inserts to the top surface of the base member layer contiguous with the first fluid barrier portions and the second fluid barrier portions; providing an upper member layer having a bottom surface from a second continuous source; attaching a plurality of chamber separators to a portion of the bottom surface of the upper member layer, or to a portion of the top surface of the base member layer; securing the base member layer and the upper member layer together, and thereby producing a plurality of cartridges; and separating each cartridge of the plurality of cartridges. Each cartridge includes an ante-chamber and an analysis chamber. The ante-chamber is defined by the base member layer, the upper member layer, a first ante-chamber insert of the plurality of first ante-chamber inserts, and a second ante-chamber insert of the plurality of second ante-chamber inserts. The analysis chamber is defined by the base member layer, the upper member layer, a first fluid barrier portion of the plurality of first fluid barrier portions, and a second fluid barrier portion of the plurality of second fluid barrier portions.

In any of the aspects or embodiments described above and herein, the first continuous source may be a first feed roll.

In any of the aspects or embodiments described above and herein, the second continuous source may be a second feed roll.

In any of the aspects or embodiments described above and herein, the plurality of first ante-chamber inserts and the plurality of second ante-chamber inserts may be provided from a third feed roll.

In any of the aspects or embodiments described above and herein, the plurality of first ante-chamber inserts and the plurality of second ante-chamber inserts may extend between the bottom surface of the upper member layer and the top surface of the base member layer.

In any of the aspects or embodiments described above and herein, the plurality of first fluid barrier portions and the plurality of second fluid barrier portions may be a hydrophobic coating configured to act as a barrier to the biological fluid sample.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. The following description and drawings are intended to be exemplary in nature and non-limiting.

### BRIEF DESCRIPTION OF THE DRAWINGS

FIG. 1 is a diagrammatic perspective view of a present disclosure cartridge embodiment, showing the top side of the cartridge.

FIG. 2 is a diagrammatic perspective view of a present disclosure cartridge embodiment shown in FIG. 1, showing the bottom side of the cartridge.

FIG. 3 is a diagrammatic sectioned perspective view of a present disclosure cartridge embodiment shown in FIG. 1.

FIG. 4 is a diagrammatic top view of a present disclosure sample chamber assembly embodiment.

FIG. 5 is a diagrammatic sectional view of a present disclosure sample chamber assembly embodiment shown in FIG. 4 along sectional line 5-5 shown in FIG. 4.

FIG. 6 is a diagrammatic sectional view of a present disclosure sample chamber assembly embodiment shown in FIG. 4 along sectional line 6-6 shown in FIG. 4.

FIG. 7 is a diagrammatic sectional view of a present disclosure sample chamber assembly embodiment shown in FIG. 4 along sectional line 7-7 shown in FIG. 4.

FIG. 8 is a diagrammatic sectional view of a present disclosure sample chamber assembly embodiment shown in FIG. 4 along sectional line 8-8 shown in FIG. 4.

FIG. 9 is a diagrammatic perspective view of a present disclosure cartridge embodiment, showing the top side of the cartridge.

FIG. 10 is a diagrammatic view of a continuous tape of sample chamber assemblies.

FIG. 11 is a diagrammatic representation of a manufacturing line for manufacturing the continuous tape of sample chamber assemblies.

FIG. 12 is a diagrammatic view of unwound base member.

FIG. 13 is a diagrammatic view of the unwound base member with the fluid barrier portions disposed on the base member.

FIG. 14 is a diagrammatic view of an unwound layer of ante-chamber insert 66 material.

FIG. 15 is a diagrammatic view of unwound upper member.

FIG. 16 is a diagrammatic view of a sample chamber assembly that has been separated from the continuous tape.

### DETAILED DESCRIPTION

The present disclosure is directed to an apparatus (e.g., a cartridge) for acquiring and quiescently holding a biological fluid sample in an analysis chamber.

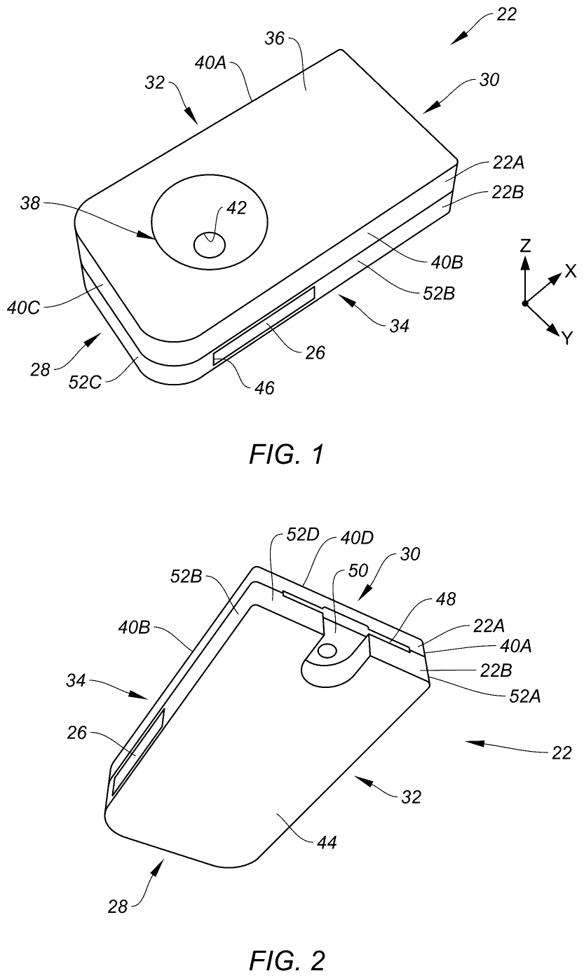

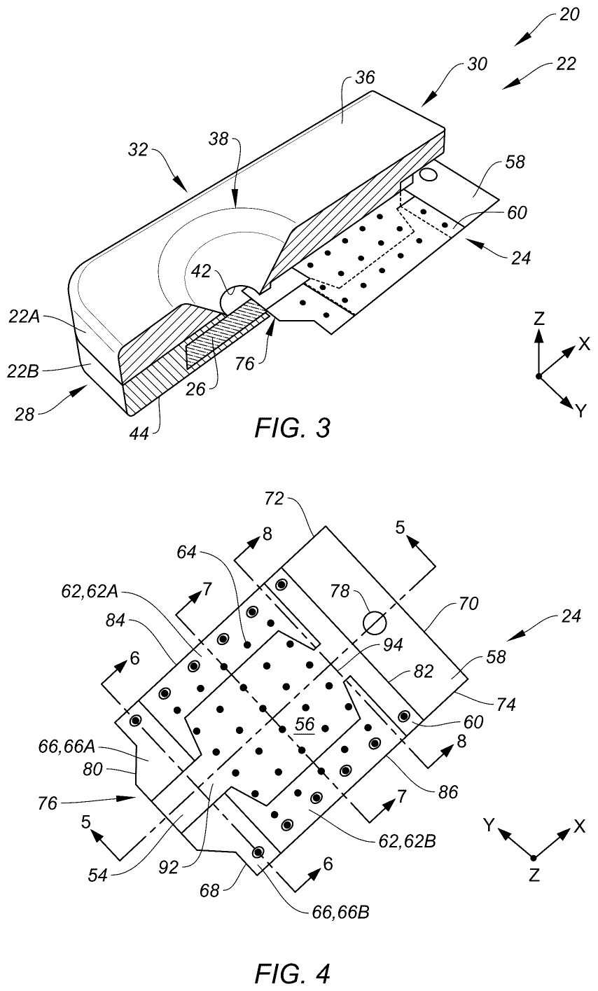

FIGS. 1-3 diagrammatically illustrate a present disclosure cartridge 20 embodiment. The cartridge 20 includes a housing 22, a sample chamber assembly 24 (see FIG. 3), and an absorbent substance 26.

The housing 22 has extends axially between a first axial end 28 and a second axial end 30, and laterally between a first lateral side 32 and a second lateral side 34. The housing 22 may be described as having an axial length extending between the first and second axial ends 28, 30 (i.e., along the X-axis), a lateral width between the first and second lateral sides 32, 34 (i.e., along the Y-axis), and a height (i.e., along the Z-axis). The housing 22 may be configured as a unitary structure or may include a plurality of elements that collectively form the housing 22. To facilitate the description herein, the housing 22 will be described and shown in terms of a rectangularly shaped housing 22 having an upper housing element 22A and a lower housing element 22B that are attached to one another. The present disclosure is not limited to this housing 22 example; i.e., not limited to a two-piece housing 22 or a rectangularly shaped housing 22.

The upper housing element 22A includes a top surface 36, at least one side surface, and a sample receiver 38. The at least one side surface includes a first side surface 40A disposed on the first lateral side 32 of the housing 22, a second side surface 40B disposed on the second lateral side 34 of the housing 22, a first end side surface 40C disposed at the first axial end 28 of the housing 22, and a second end side surface 40D disposed at the second axial end 30 of the housing 22. The sample receiver 38 is formed as a cavity that extends through the upper housing element 22A; e.g., in a direction along the Z-axis. The sample receiver 38 tapers from an opening at the top surface 36 to an interior aperture 42 disposed at an interior side of the upper housing element 22A; i.e., the sample receiver 38 converges from the opening to the interior aperture 42. In the embodiment shown in FIGS. 1-3, the sample receiver 38 has a truncated cone configuration with the opening having a first diameter and the interior aperture 42 having a second diameter which is smaller than the first diameter. The present disclosure is not limited to any particular sample receiver 38 configuration. However, a sample receiver 38 that tapers is understood to facilitate sample collection and flow through the sample receiver 38. In the example shown in FIGS. 1-3, the upper housing element 22A is diagrammatically shown as a solid body. The present disclosure is not limited to a solid body configuration.

The lower housing element 22B includes a bottom surface 44, at least one side surface, an absorbent substance cavity 46, a chamber slot 48, and an actuator slot 50. The at least one side surface includes a first side surface 52A disposed on the first lateral side 32, a second side surface 52B disposed on the second lateral side 34, a first end side surface 52C disposed at the first axial end 28, and a second end side surface 52D disposed at the second axial end 30. As can be seen in FIGS. 1-3, the upper and lower housing elements 22A, 22B are configured so that the end surfaces 40C, 52C, 40D, 52D and the side surfaces 40A, 52A, 40B, 52B align with one another. The absorbent substance cavity 46 (and therefore the absorbent substance 26) is aligned with the interior aperture 42 of the sample receiver 38 when the housing 22 is in an assembled configuration. The example cartridge 20 shown in FIGS. 1-3 illustrates the absorbent substance 26 extending to and exposed at a lateral side (e.g., side surface 52D) of the housing 22. The exposure of the absorbent substance 26 on the lateral side is not required. The chamber slot 48 is configured to receive the sample chamber assembly 24. The chamber slot 48 extends from a first end that is axially aligned with the interior aperture 42 of the sample receiver 38 to the second axial end 30 of the cartridge 20. At the second axial end 30 of the cartridge 20, the chamber slot 48 is open at allow the sample chamber assembly 24 to be inserted and removed from the housing 22. The actuator slot 50 extends from the bottom surface 44 of the lower housing element 22B through to the chamber slot 48 to permit access to the sample chamber assembly 24 as will be described herein.

In the cartridge 20 embodiment shown in FIGS. 1-3, the chamber slot 48 is described as being disposed within the lower housing element 22B. In an alternative embodiment, a first portion of the chamber slot 48 may be disposed within the upper housing element 22A and a second portion of the chamber slot 48 may be disposed in the lower housing element 22B. In this embodiment, when the upper and lower housing elements 22A, 22B are attached to one another, the first and second portions of the chamber slot 48 collectively form the chamber slot 48. In yet another alternative embodiment, the chamber slot 48 may be disposed within the upper housing element 22A.

Referring to FIGS. 4-8, a sample chamber assembly 24 embodiment is diagrammatically shown. This embodiment represents an example of sample chamber assembly 24 and the present disclosure is not limited thereto. U.S. patent application Ser. No. 17/612,242, which is commonly owned with the present application and to which priority is claimed, discloses relevant information regarding the chamber assembly and is hereby incorporated by reference in its entirety. As will be detailed herein, the sample chamber assembly 24 includes an ante-chamber 54 and an analysis chamber 56. Both the ante-chamber 54 and an analysis chamber 56 are configured to allow a biological fluid sample to be drawn into and travel within the respective chamber 54, 56 by capillary forces.

The sample chamber assembly 24 includes a base member 58, an upper member 60, a fluid barrier 62, chamber separators 64, and ante-chamber inserts 66. The base member 58 extends axially (i.e., along the X-axis) from an inlet end 68 to a distal end 70 and laterally (i.e., along the Y-axis) from a first lateral side 72 to a second lateral side 74. As shown in FIG. 4, the inlet end 68 may be configured to be a part of a centrally located tab 76 that extends axially outward. The base member 58 may include an actuator aperture 78 disposed adjacent the distal end 70. As will be detailed herein, a portion of the base member 58 forms the analysis chamber 56; i.e., the “analysis chamber portion of the base member”. The analysis chamber portion of the base member 58 is transparent. In some embodiments, the entire base member 58 may be transparent. A “transparent” member refers to a member that is configured to allow electromagnetic radiation to pass through the member with negligible loss or interference for the purpose of performing the analysis of the biological fluid sample. The electromagnetic radiation is within a range of wavelengths selected from ultraviolet (UV), visible, and/or infrared (IR) that are useful in the analysis of the biological fluid sample.

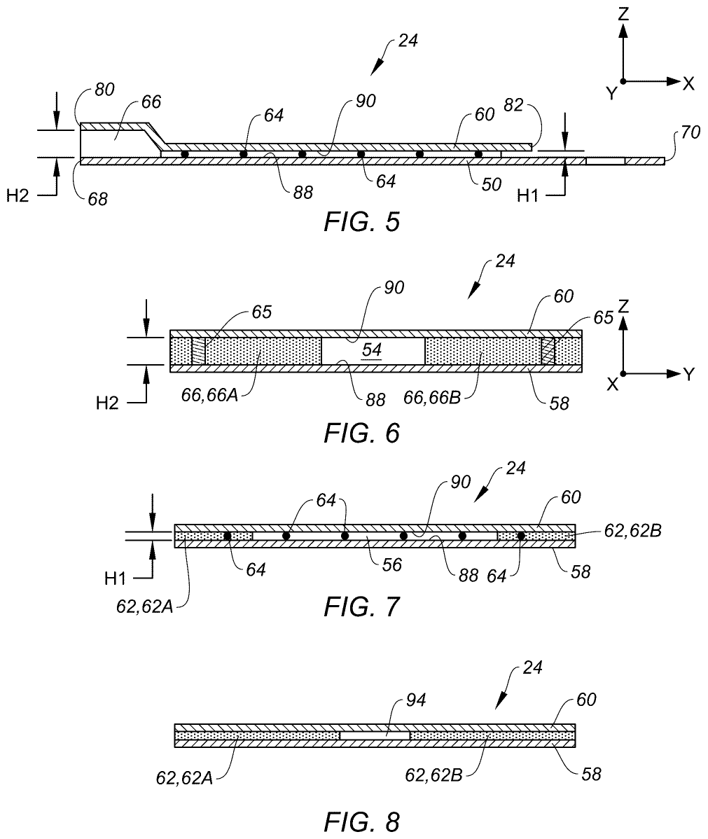

Still referring to FIGS. 4-8, the upper member 60 extends axially (i.e., along the X-axis) from an inlet end 80 to a distal end 82 and laterally (i.e., along the Y-axis) from a first lateral side 84 to a second lateral side 86. Like the base member 58, the inlet end 80 (e.g., see FIG. 5) of the upper member 60 may be configured to be a part of a centrally located tab 76 that extends axially outward. The axial length of the upper member 60 is less than the base member 58, thereby leaving a portion of the base member 58 uncovered adjacent the distal end 70 of the base member 58. As can be seen in FIG. 5, the base member 58 may have a planar configuration and the upper member 60 may have a stepped configuration. The height differences (i.e., the separation distances H1, H2 between the top surface 88 of the base member 58 and the bottom surface 90 of the upper member 60) created by the stepped configuration will be detailed herein. As will be detailed herein, a portion of the upper member 60 forms the analysis chamber 56; i.e., the “analysis chamber portion of the upper member”. The analysis chamber portion of the upper member 60 is transparent.

Referring to FIGS. 4, 7, and 8, the fluid barrier 62 includes a first fluid barrier portion 62A and a second fluid barrier portion 62B disposed between the base member 58 and the upper member 60. The first fluid barrier portion 62A may be disposed adjacent the first lateral sides 72, 84 of the base and upper members 58, 60. The second fluid barrier portion 62B may be disposed adjacent the second lateral side 74, 86 of the base and upper members 58, 60. The first and second fluid barrier portions 62A, 62B are collectively configured to define an inlet passage 92, the analysis chamber 56, and an air exhaust passage 94. As will be detailed herein, the inlet passage 92 provides fluid communication between an ante-chamber 54 and the analysis chamber 56. In the embodiment shown in FIGS. 4-8, the inlet passage 92, the analysis chamber 56, and the air exhaust passage 94 are centered along an axially extending centerline (i.e., along the X-axis) of the sample chamber assembly 24 but that is not required. FIG. 4 is a diagrammatic top view that illustrates an example of a first fluid barrier portion 62A and a second fluid barrier portion 62B. FIG. 7 is a sectional view that passes through the analysis chamber 56 and the first and second fluid barrier portions 62A, 62B at a central position of the analysis chamber 56. FIG. 8 is a sectional view that passes through an air exhaust passage 94 and the first and second fluid barrier portions 62A, 62B at position axially beyond the analysis chamber 56.

The fluid barrier 62 prevents biological fluid from crossing the fluid barrier 62. Hence, biological fluid passing through the inlet passage 92 is maintained in the inlet passage 92 (i.e., between the barrier portions 62A, 62B) as it travels through the inlet passage 92 and into the analysis chamber 56. In similar fashion, the fluid barrier portions 62A, 62B on each lateral side in combination with the base and upper members 58, 60 define the analysis chamber 56. The fluid barrier portions 62A, 62B limit the extent to which the biological fluid can spread out laterally within the analysis chamber 56. The fluid barrier 62 may be any structure or material that acts as a barrier. For example, in some embodiments a hydrophobic coating may be used as a barrier for a given biological fluid. In the case of a coating, the coating may be disposed on the bottom surface 90 of the upper member 60 and/or the top surface 88 of the base member 58 (i.e., the member surfaces that define the analysis chamber 56) and may not necessarily be a solid material that extends the entire distance between the upper member 60 and the base member 58. In other embodiments, the fluid barrier 62 may be a component that expands between the upper and base members 58, 60; e.g., an expandable material or a compressible material. The diagrammatic representation of a sample chamber assembly 24 shown in FIG. 4 shows the first and second barrier portions 62A, 62B as completely occupying the region outside of the analysis chamber 56. In some embodiments, the first and second barrier portions 62A, 62B may be configured as lines of barrier material that prevents the lateral expansion of biological fluid beyond the respective barrier portion; i.e., the present disclosure does not require the first and second barrier portions 62A, 62B to cover all of the area outside of the analysis chamber 56. The present disclosure is not limited to any particular fluid barrier configuration or fluid barrier material.

The chamber separators 64 are disposed between the base member 58 and the upper member 60 within the analysis chamber 56. In some embodiments, the chamber separators 64 may also be disposed between the base member 58 and the upper member 60 around the periphery of the analysis chamber 56; e.g., in the region shown in FIG. 4 as being occupied by the first and second barrier portions 62A, 62B. The chamber separators 64 are disposed to maintain separation between the base member 58 and the upper member 60 and thereby create the analysis chamber 56 therebetween.

The chamber separators 64 may have any geometric configuration that permits them to extend between the base member 58 and the upper member 60 and provide the separation therebetween. Non-limiting examples of separator geometries include spherical separators, parallelepipeds (i.e., three-dimensional rectangular geometric shapes), circular columns, and the like. In some embodiments, the chamber separators 64 may be structures that are independent of the base member 58 or the upper member 60. In some embodiments, the chamber separators 64 may be structures that are integral with the base member 58 or the upper member 60. The dimension of a chamber separator 64 that extends between the base and upper members 58, 60 is referred to herein as the height of the chamber separator 64. The height of the chamber separators 64 typically do not equal one another exactly but are within commercially acceptable tolerance for spacing means used in similar analysis apparatus. At least one of the base member 58, the upper member 60, or the chamber separators 64 may be sufficiently flexible to permit the height (H1) of the analysis chamber 56 (i.e., the distance between the bottom surface 90 of the upper member 60 and the top surface 88 of the base member 58) to approximate the mean height of the chamber separators 64. For example, in some embodiments, the chamber separators 64 may consist of a material that has greater flexibility than one or both of the base member 58 and the upper member 60; i.e., relatively speaking, one or both of the base member 58 and the upper member 60 may be considered to be rigid relative to the chamber separators 64 and the chamber separators 64 may be considered to be flexible relative to one or both of the base member 58 and the upper member 60. In other embodiments, the chamber separators 64 may consist of a material that has less flexibility than one or both of the base member 58 and the upper member 60; i.e., relatively speaking, one or both of the base member 58 and the upper member 60 may be considered to be flexible relative to the chamber separator 64 and the chamber separator 64 may be considered to be rigid relative to one or both of the base member 58 and the upper member 60. Regardless of whether only one of the base member 58, the upper member 60, or the chamber separators 64 is flexible, or more than one is flexible, the aforesaid relative flexibility of the base member 58, the upper member 60, and the chamber separators 64 collectively create an analysis chamber 56 having a height that is known or determinable with a high degree of uniformity. Subject to the flexibility characteristics described above (which may also be described as deformability), the base member 58 and the upper member 60 can be made from a variety of materials, provided at least the analysis chamber portion of the base member 58 and the upper member 60 is transparent. Transparent plastic films consisting of acrylic, polycarbonate, or polystyrene are examples of acceptable materials for the base member 58 and the upper member 60. Plastic beads formed from polystyrene, polycarbonate, silicone, or the like may be used for the chamber separators 64. U.S. Pat. Nos. 8,241,572 and 8,638,427, which describe separators and materials that are capable of establishing an analysis chamber 56 of substantially uniform height, are each hereby incorporated by reference in their respective entirety.

Referring to FIG. 4, the ante-chamber inserts 66 include a first ante-chamber insert 66A and a second ante-chamber insert 66B that are disposed between the base member 58 and the upper member 60 contiguous with the inlet end of the sample chamber assembly 24. In those embodiments that include a centrally located tab 76 that extends axially outward, the ante-chamber inserts 66A, 66B may be disposed between the base member 58 and the upper member 60 within the tab 76 as well. The first and second ante-chamber inserts 66A, 66B are laterally spaced apart from one another and together with the base member 58 and the upper member 60 define the ante-chamber 54. The ante-chamber 54 has a cross-sectional geometry that includes a height (“H2”) that is the distance between the top surface 88 of the base member 58 and the bottom surface 90 of the upper member 60 within the ante-chamber 54. The analysis chamber 56, in contrast, has a height (“H1”) that is the distance between the top surface 88 of the base member 58 and the bottom surface 90 of the upper member 60 within the analysis chamber 56. The height (H2) of the ante-chamber 54 causes the sample to be drawn into the ante-chamber 54 by capillary forces in a relatively rapid manner. The term “relatively rapid” is used to indicate that the amount of time for the fluid sample to be drawn into the ante-chamber 54 from a source (e.g., the sample receiver 38) by capillary action may be on the order of six times faster (or multiples of that) than the amount of time for the fluid sample to be drawn into the analysis chamber 56 from the ante-chamber 54. Of course, the specific fill times may vary depending on the type of biological fluid (e.g., including the viscosity of the fluid) and environmental factors such as temperature and the like. Using a biological fluid in the form of a whole blood sample, embodiments of the present disclosure may be configured so that the whole blood sample is drawn into and fills the ante-chamber 54 in the range of about 0.4 seconds to about 3.0 seconds, and the same sample is substantially all drawn into analysis chamber 56 from the ante-chamber 54 in the range of about 5.0 seconds to about 30.0 seconds. To achieve the rapid blood flow from a source (i.e., the sample receiver 38) into the ante-chamber 54 relative to the blood flow from the ante-chamber 54 into the analysis chamber 56, the height (H2) of the ante-chamber 54 may be in the range of about 4 to 10 times the height (H1) of the analysis chamber 56. It is also understood that during the relatively rapid flow into the ante-chamber 54, a whole blood sample will remain in substantially the same form as it is within the source; e.g., the same constituent (e.g., WBCs, RBCs, plasma, etc.) ratio and is therefore a relatively accurate representation of the sample as it exists in the source. In some embodiments, the height (H2) of the ante-chamber 54 may be defined by the first and second ante-chamber inserts 66A, 66B. In these embodiments, the first and second ante-chamber inserts 66A, 66B may also be configured to function as fluid barriers that maintain the biological fluid within the ante-chamber 54 as the sample is drawn into the ante-chamber 54 and transferred from the ante-chamber 54 and into the analysis chamber 56. The present disclosure is not, however, limited to first and second ante-chamber inserts 66A, 66B that extend between the base member 58 and the upper member 60. For example, in some embodiments, the separators (e.g., like the chamber separators 64 described herein—but larger to create the 4-10 times larger height) may be used as first and second ante-chamber inserts 66A, 66B in combination with a fluid barrier material affixed to the top surface 88 of the base member 58 and the bottom surface 90 of the upper member 60.

In some embodiments, the volume of the ante-chamber 54 is less than or equal to the volume of the analysis chamber 56. As a result, a portion of the biological fluid sample deposited into the sample receiver 38 may be drawn into the analysis chamber 56 without the analysis chamber 56 being over filled. As an example, the volume of the ante-chamber 54 may be in the range of 80%-90% of the volume of the analysis chamber 56. The present disclosure is not limited to particular relative ante-chamber 54 and analysis chamber 56 volumes other than the ante-chamber 54 volume being less than or equal to the analysis chamber 56 volume.

Some or all the elements of the sample chamber assembly 24 (e.g., the base member 58, the upper member 60, the fluid barrier 62, and the ante-chamber inserts 66A, 66B may be attached to one another. Non-limiting examples of how the elements may be attached to one another include ultrasonic tacking, or thermal tacking, or by adhesive, or mechanical fastener, or the like. FIG. 6 diagrammatically illustrates some points of attachment 65 that may be created by tacking, or adhesive, or the like.

In some embodiments, sample modifying materials useful for the analysis of the biological fluid sample may be disposed within the ante-chamber 54, or within the analysis chamber 56, or in both. The present disclosure does not require the inclusion of any such materials. In those instances wherein sample modifying materials are included, the present disclosure is not limited to any particular materials. As an example, in those instances wherein the present disclosure cartridge 20 is configured to acquire and hold a whole blood sample, material that may be deposited within the cartridge 20 include colorants and anticoagulants.

The absorbent substance 26 may be any material that will absorb the biological fluid being collected using the present disclosure cartridge 20; e.g., if the cartridge 20 is configured to collect a whole blood sample, then the absorbent substance 26 is configured to absorb whole blood sample. Non-limiting examples of an absorbent substance 26 include a cellulose material, a cotton material, blotting paper, and the like. Any material that is capable of absorbing a volume of biological fluid sample in a period of time that is useful to prevent spillage from the cartridge 20 during use would be acceptable. For example, an absorbent substance 26 that is able to absorb excess sample material that is not drawn into the ante-chamber 54 in about the time it takes the fluid sample to transfer from the ante-chamber 54 into the analysis chamber 56 would be useful. The present disclosure is not limited to any particular absorbent substance 26.

To illustrate the utility of the present disclosure cartridge 20, use of the cartridge 20 will be described hereinafter in the context of acquiring and quiescently holding a biological fluid sample in the form of a whole blood sample in the analysis chamber 56. Referring to FIG. 3, prior to using the cartridge 20, a sample chamber assembly 24 is loaded into the cartridge 20 by inserting the sample chamber assembly 24 into the chamber slot 48. When the sample chamber assembly 24 is fully received within the chamber slot 48, the inlet end of the sample chamber assembly 24 (e.g., the tab 76 if included) is exposed at the interior aperture 42 of the sample receiver 38. The absorbent substance 26 is also exposed at the interior aperture 42 of the sample receiver 38.

A sample of whole blood (e.g., from a capillary puncture, or the like) is deposited into the sample receiver 38. The sample receiver 38 may be sized as an indication (or marked to indicate) an appropriate amount of blood sample to deposit. Once deposited, the blood sample travels through the sample receptable 38 and encounters both the absorbent substance 26 and the inlet end of the sample chamber assembly 24. Blood sample encountering the inlet end, will be drawn into the ante-chamber 54 by capillary forces. The blood sample drawn into the ante-chamber 54 will travel axially within the ante-chamber 54 relatively rapidly as a result of the ante-chamber 54 geometry. When the blood sample encounters the entry to the analysis chamber 56, capillary forces will draw the blood sample into the analysis chamber 56. Virtually all of the sample received within the ante-chamber 54 will travel into the analysis chamber 56 by capillary force and therefore no external force is required. Once the ante-chamber 54 has filled with the blood sample, the absorbent substance 26 will draw away and retain any excess blood sample thereby preventing continuous filling (and possible overflowing of the analysis chamber 56). Thus, the absorbent substance 26 functions to allow filling of the ante-chamber 54, which fills rapidly, and to remove the excess blood sample remaining after filling the ante-chamber 54 before the analysis chamber 56 is substantially filled. The sample within the ante-chamber 54 travels axially away from the inlet end thereby separating from any blood sample that may be engaged with the absorbent substance 26. As indicated herein, the present disclosure cartridge 20 is configured so that virtually all the sample contained within the antechamber 54 migrates from the ante-chamber 54 and into the analysis chamber 56 by capillary force.

The blood sample enters the analysis chamber 56 and spreads out within the analysis chamber 56. The fluid barrier portions 62A, 62B on the lateral sides of the analysis chamber 56 provide fluid flow limits. Air that is within the analysis chamber 56 as the blood sample is drawn into the analysis chamber 56 may exit the analysis chamber 56 via the air exhaust passage 94 or through the sides of the chamber in the case that fluid barriers 62 do not exclude the outward flow of air. Capillary forces associated with the blood sample within the analysis chamber 56 will act on the base member 58 and the upper member 60, drawing the base member 58 and upper member 60 toward one another. As described herein, one or more of the base member 58, the upper member 60, and the chamber separators 64 is sufficiently flexible (i.e., deformable) such that the height (H1) of the analysis chamber 56 has a high degree of uniformity on a per area basis and may be considered to be constant within the region occupied by the blood sample. The exact height (H1) of the analysis chamber 56 may be determined based on empirical data or it may be measured. Regardless of how the analysis chamber 56 height value is determined, once the value is known the volume of the sample within the analysis chamber 56 can be determined.

The cartridge 20 with the blood sample now acquired and loaded into the analysis chamber 56 may be utilized with an analysis device (not shown) configured to draw the sample chamber assembly 24 out of the cartridge 20; e.g., by engaging the actuator aperture 78 disposed in the base member 58 with an actuator that draws the assembly out of the cartridge 20.

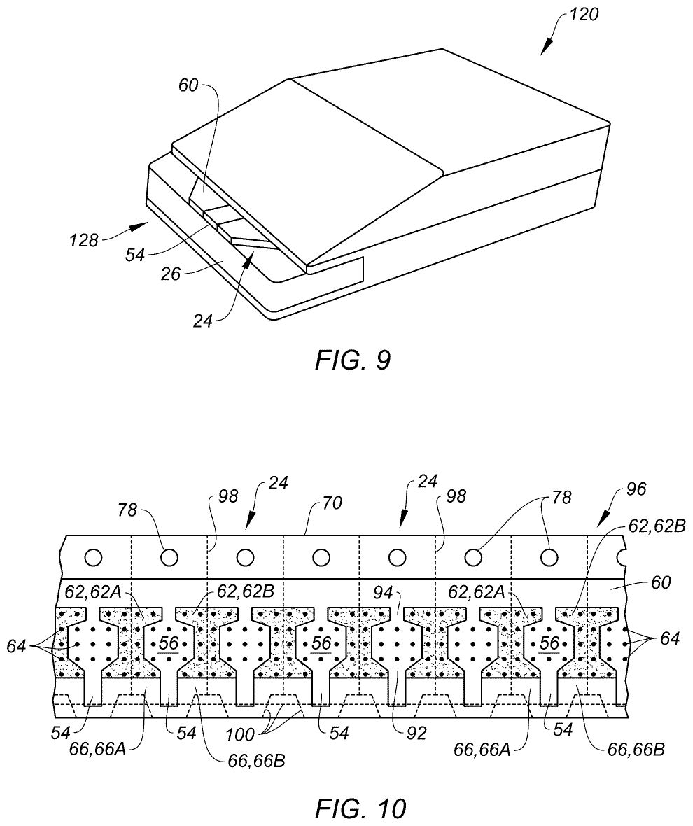

FIG. 9 illustrates another cartridge 120 embodiment example. In this example, the inlet end of the sample chamber assembly 24 and the absorbent substance 26 are exposed at the first axial end 128 of the cartridge 120, and the sample receiver 38 is omitted. Using a whole blood sample as an example again, a blood sample from a capillary puncture (or a drop of sample from another source such as a collection tube) may be touched to the exposed ante-chamber 54 at the inlet end of the sample chamber assembly 24. As described above, the whole blood sample will be relatively rapidly drawn into the ante-chamber 54 causing the ante-chamber 54 to fill. The transparency of the upper member 60 of the ante-chamber 54 may facilitate the sample loading by giving a visual indication regarding whether the ante-chamber 54 is filled. Once the ante-chamber 54 is filled with sample (or not 100% filled, but a sufficient amount of sample is transferred to the ante-chamber 54), the source may be removed from inlet end. The position of the absorbent substance 26 relative to the inlet end will enable the absorbent substance 26 to absorb and safely contain any blood sample not drawn into the ante-chamber 54. The sample will subsequently be transferred into the analysis chamber 56 (e.g., see FIG. 4) as described herein.

An aspect of the present disclosure is directed to a method of manufacturing the sample chamber assembly. FIG. 10 illustrates a plurality of sample chamber assemblies 24 attached to one another in a continuous tape 96. As described herein, an embodiment of a present disclosure sample chamber assembly 24 may include a base member 58, an upper member 60, a fluid barrier 62, chamber separators 64, and ante-chamber inserts 66. Within FIG. 10, the plurality of sample chamber assemblies 24 are attached to one another at the dashed lines 98 that are coincident with the lateral edges 72, 74, 84, 86 of the base member 58 and upper member 60; e.g., see FIG. 4. Dashed lines 100 are coincident with the edges at the inlet ends 68, 80 of the base member 58 and upper member 60. As will be detailed herein, once assembled, each sample chamber assembly 24 within the continuous tape 96 can be separated from the adjacent sample chamber assemblies 24 by shearing the layers 58, 60, 66 at the dashed lines 98, 100.

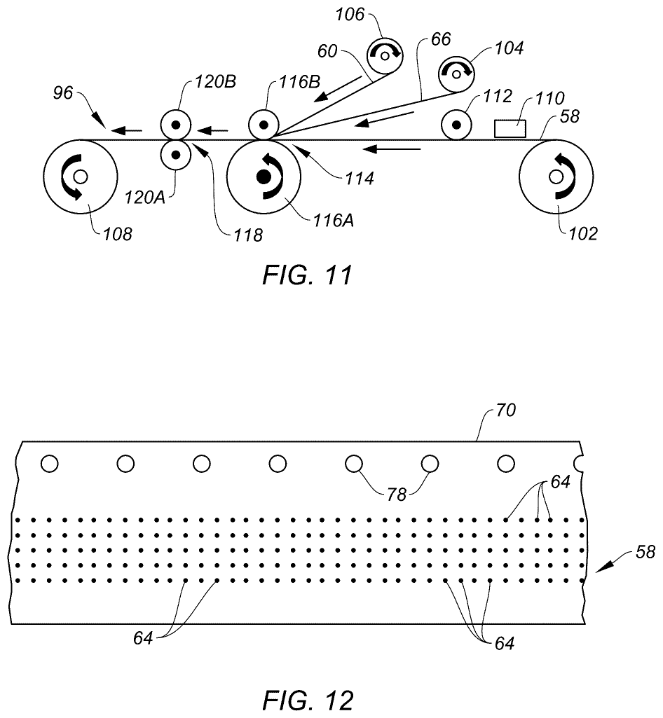

FIG. 11 diagrammatically illustrates a manufacturing line that may be used to form a continuous tape 96 of sample chamber assemblies 24. A first feed roll 102 is wrapped with a continuous sheet of the base member 58 layer. A second feed roll 104 is wrapped with a continuous sheet of the ante-chamber inserts 66. A third feed roll 106 is wrapped with a continuous sheet that is the upper member 60 layer. In FIG. 11, a take-up roll 108 is disposed to receive and wind up the continuous tape 96 of assembled sample chamber assemblies 24. The diagram shown in FIG. 11 is not intended to represent an actual manufacturing line but rather is intended to diagrammatically illustrate the components within a manufacturing line and how the various components may be assembled.

Referring to FIGS. 10, 11, and 12, the base member 58 layer is unwound from the first feed roll 102 during the manufacturing process. FIG. 12 diagrammatically illustrates the base member 58 after it is unwound from the first feed roll 102, including the distal end 70 with the adjacent actuator apertures 78. In some embodiments, the actuator apertures 78 may be created in the base member 58 at a later point during the manufacturing process. A distribution of the chamber separators 64 may be applied to the base member 58 prior to the base member 58 being wound onto the first feed roll 102 or after the base member 58 is unwound from the first feed roll 102 or may be applied to the inner surface of top layer 60 in a similar manner. FIG. 11 includes a chamber separator application station 110 just downstream of the first feed roll 102 to diagrammatically illustrate the application of the chamber separators 64 to the base member 58 layer. As will be detailed herein, the chamber separators 64 may be included in the chamber assembly lay-up using various different processes and the present disclosure is not limited to any particular process.

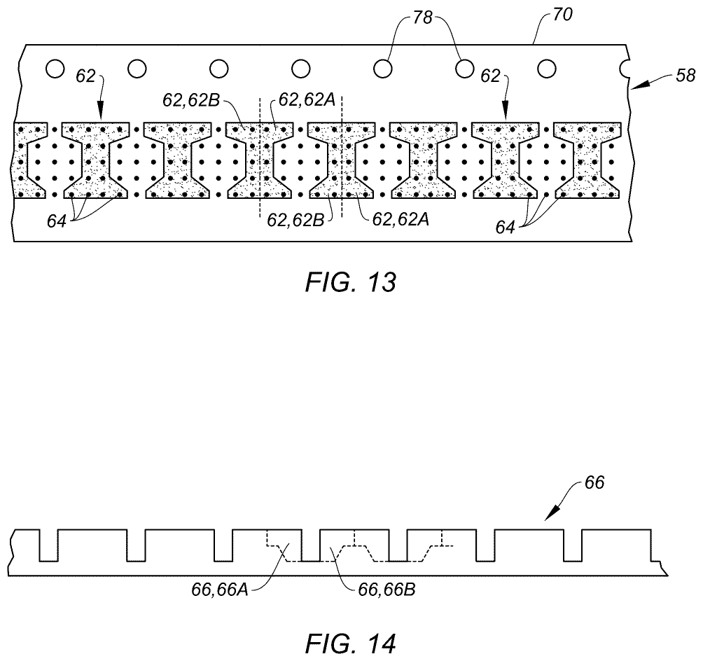

Referring to FIGS. 10, 11, and 13, the manufacturing line may include a station (e.g., the “fluid barrier station 112”) for adding the fluid barrier 62 to the unwound base member 58 layer. As detailed herein, the fluid barrier 62 may include a first fluid barrier portion 62A and a second fluid barrier portion 62B that are disposed between the base member 58 and the upper member 60 when assembled. The specific methodology used to add the fluid barrier 62 to the base member 58 may depend on the characteristics of the barrier layer 62; e.g., whether the barrier layer 62 is a coating, or a layer of material, or the like. A fluid barrier 62 in the form of a coating may be added to the base member 58, for example, using a rotary press, or a stamping press, or the like. The present disclosure is not limited to any particular methodology for adding the fluid barrier 62 material to the base member 58 layer.

Referring to FIGS. 10, 11, and 14, the manufacturing line is diagrammatically shown with the ante-chamber insert 66 material being unwound from the second feed roll and added to the base member 58 layer. In this example, the ante-chamber insert 66 is diagrammatically indicated as a layer of material wound on the second feed roll 104 but the present disclosure is not limited thereto. The specific methodology used to add the ante-chamber insert 66 material to the base member 58 may depend on the characteristics of the ante-chamber insert 66; e.g., whether the ante-chamber insert 66 material is a layer of material, or a coating, or the like.

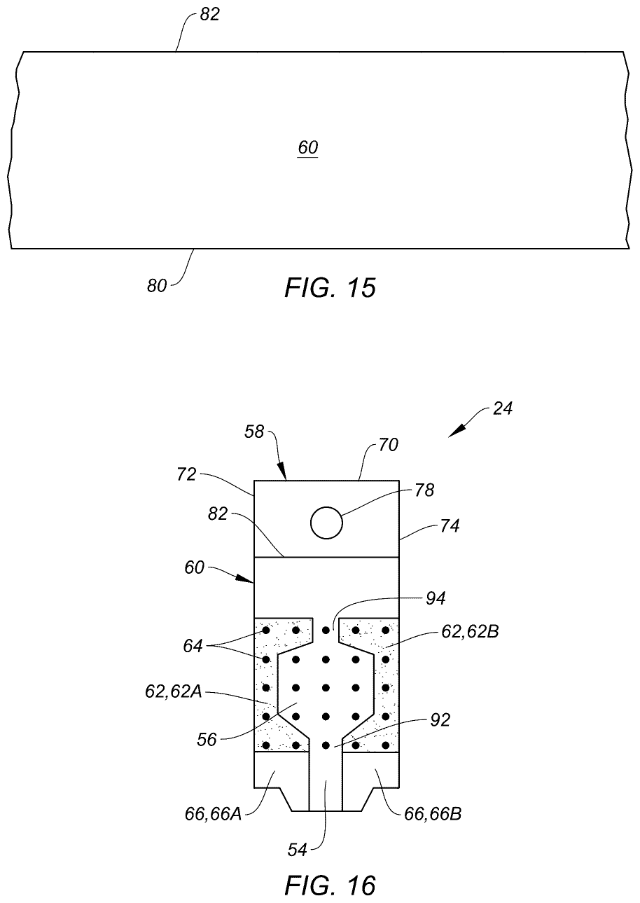

Referring to FIGS. 10, 11, and 15, the upper member 60 layer is unwound from the third feed roll 106 during the manufacturing process. FIG. 15 diagrammatically illustrates the upper member 60 after being unwound. In some embodiments (not shown), a distribution of the chamber separators 64 may be applied to the upper member 60 prior to the upper member 60 being incorporated into the sample chamber assembly 24 rather than being applied to the base member 58.

Referring to FIG. 11, the ante-chamber insert 66 material and the upper member 60 layer are shown feeding through a first nip 114 disposed between a pair of rollers 116A, 116B. At the first nip 114 or before the first nip 114, a line (or other distribution format) of adhesive may be applied to one or more of the sample chamber assembly constituents to facilitate assembly of the constituents. The first nip 114 may be configured to achieve proper alignment of the sample chamber assembly components 58, 60, 66. A second nip 118 between a pair of rollers 120A, 120B may be disposed downstream of the first nip 114. The second nip 118 may be used to consolidate attachment of the assembly constituents 58, 60, 66. In some embodiments, the constituent layers 58, 60, 66 within the assembly may be thermally bonded (e.g., “welded”) to one another (e.g., at the second nip), thereby obviating the need to use an adhesive. The present disclosure is not limited to any particular mechanism for attaching the constituent layers within the sample chamber assembly.

FIG. 11 diagrammatically illustrates the assembled sample chamber assemblies 24 in continuous tape 96 form being wound up on a take-up roll 108. The continuous tape 96 is subsequently subjected to a cutting process in which the individual sample chamber assemblies 24 are separated from the continuous tape 96 by cutting at positions identified by the dashed lines 98 that are coincident with the lateral edges 72, 74, 84, 86 of the base member 58 and upper member 60, and cutting at the dashed lines 100 to expose the inlet of the ante-chamber 54. FIG. 16 illustrates an assembled sample chamber assembly 24 that has been cut free of the continuous tape 96. The present disclosure does not require the continuous tape 96 of assembled sample chamber assemblies 24 be wound up on a take-up roll 108. For example, after assembly is completed, the continuous tape 96 may then be subject to the described cutting process to produce the individual sample chamber assemblies 24 and thereby avoid the take-up roll 108.

To be clear, the manufacturing process described above and shown in FIGS. 10-16 is understood to be a viable process that may be used, but the present disclosure is not limited thereto. The order of manufacturing steps may be changed, and fewer or more steps may be utilized.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The terms “substantially,” “about,” “approximately,” and other similar terms of approximation used within this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims and should be understood as falling within the scope of the claims unless explicitly stated otherwise.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

1. A cartridge for acquiring a biological fluid sample, comprising:
a sample chamber assembly that includes a base member and an upper member, wherein an ante-chamber is disposed between the base member and the upper member at an inlet end of the sample chamber assembly, wherein an analysis chamber is disposed between the base member and the upper member and is in fluid communication with the ante-chamber, and wherein the ante-chamber and the analysis chamber are configured such that capillary forces draw a biological fluid sample into the ante-chamber and subsequently draw the biological fluid sample from the ante-chamber and into the analysis chamber;
a housing configured to internally receive the sample chamber assembly in a manner such that the inlet end of the sample chamber assembly is disposed for engagement with the biological fluid sample; and
an absorbent substance provided with the housing and disposed in close proximity to the inlet end of the sample chamber assembly and configured to absorb the biological fluid sample.

2. The cartridge of claim 1, wherein the housing includes a sample receiver that is configured to receive the biological fluid sample and to position the biological fluid sample for transfer to the ante-chamber at the inlet end of the sample chamber assembly.

3. The cartridge of claim 2, wherein the housing has an axial length that extends between a first axial end and a second axial end;
wherein the housing includes a first slot configured to receive the sample chamber assembly, wherein the first slot extends within the housing from the second axial end of the housing to the sample receiver.

4. The cartridge of claim 3, wherein the housing includes a first housing element and a second housing element that are configured to be attached to one another.

5. The cartridge of claim 4, wherein the sample receiver is disposed in the first housing element.

6. The cartridge of claim 5, wherein the first slot is formed within the second housing element.

7. The cartridge of claim 3, wherein the first slot is configured to fully receive the sample chamber assembly, and the first slot is configured such that the inlet end of the sample chamber assembly fully received within the first slot is disposed to receive biological fluid sample from the sample receiver.

8. The cartridge of claim 7, wherein the sample receiver converges from an opening to an interior aperture that is positioned to permit biological fluid transfer from the sample receiver to the ante-chamber.

9. The cartridge of claim 8, wherein the absorbent substance is disposed to absorb biological fluid sample that has exited the sample receiver and has not entered the ante-chamber.

10. The cartridge of claim 9, wherein the absorbent substance is configured to absorb whole blood.

11. The cartridge of claim 7, further comprising a second slot;
wherein the sample chamber assembly includes an actuator aperture configured for engagement with an actuator, wherein the second slot is configured to provide access to the actuator aperture when the sample chamber assembly is received within the housing.

12. The cartridge of claim 1, wherein the sample chamber assembly further comprises a pair of first fluid barriers that in combination with the base member and the upper member define the ante-chamber, and wherein the ante-chamber has a first height that extends between a top surface of the base member and a bottom surface of the upper member.

13. The cartridge of claim 12, wherein the sample chamber assembly further comprises a pair of second fluid barriers that in combination with the base member and the upper member define the analysis chamber, and wherein the analysis chamber has a second height that extends between the top surface of the base member and the bottom surface of the upper member, wherein the first height is greater than the second height.

14. The cartridge of claim 13, wherein the ante-chamber is configured relative to the analysis chamber such that the biological fluid sample is drawn into the ante-chamber by capillary force in a first period of time, and the biological fluid sample is drawn into the analysis chamber from the ante-chamber by capillary force in a second period of time, wherein the second period of time is greater than the first period of time.

15. A method of manufacturing a plurality of cartridges for holding a biological fluid sample, the method comprising:
providing a base member layer having a top surface from a first continuous source;
attaching a plurality of first fluid barrier portions and a plurality of second fluid barrier portions to the top surface of the base member layer;
attaching a plurality of first ante-chamber inserts and a plurality of second ante-chamber inserts to the top surface of the base member layer contiguous with the first fluid barrier portions and the second fluid barrier portions;
providing an upper member layer having a bottom surface from a second continuous source;
attaching a plurality of chamber separators to a portion of the bottom surface of the upper member layer, or to a portion of the top surface of the base member layer;
securing the base member layer and the upper member layer together, and thereby producing a plurality of cartridges, wherein each cartridge includes:
an ante-chamber defined by the base member layer, the upper member layer, a first ante-chamber insert of the plurality of first ante-chamber inserts, and a second ante-chamber insert of the plurality of second ante-chamber inserts; and
an analysis chamber defined by the base member layer, the upper member layer, a first fluid barrier portion of the plurality of first fluid barrier portions, and a second fluid barrier portion of the plurality of second fluid barrier portions; and
separating each said cartridge of the plurality of cartridges.

16. The method of claim 15, wherein the first continuous source is a first feed roll.

17. The method of claim 16, wherein the second continuous source is a second feed roll.

18. The method of claim 17, wherein the plurality of first ante-chamber inserts and the plurality of second ante-chamber inserts are provided from a third feed roll.

19. The method of claim 17, wherein the plurality of first ante-chamber inserts and the plurality of second ante-chamber inserts extend between the bottom surface of the upper member layer and the top surface of the base member layer.

20. The method of claim 19, wherein the plurality of first fluid barrier portions and the plurality of second fluid barrier portions are a hydrophobic coating configured to act as a barrier to the biological fluid sample.
